(19) United States
(12) Patent Application Publication
(10) Pub. No.: US 2002/0078200 A1
(43) Pub. Date: Jun. 20, 2002

(54) Printer configuration service through a firewall

(76) Inventor: Janine L. Helms, Boise, ID (US)

Correspondence Address: HEWLETT-PACKARD COMPANY, Intellectual Property Adminstration, P.O. Box 272400, Fort Collins, CO, 80527-2400, US

(21) Appl. No.: 09/745,379

(22) Filed: Dec. 18, 2000

(51) Int. Cl. G06F 15/173

(52) U.S. Cl. 709/225; 710/8

(57) ABSTRACT

The described system includes a web site that is used by a customer to determine a default device configuration that corresponds to one or more peripheral devices in the company intranet. The peripheral device is pre-configured to communicate a request for the default device configuration to the web site upon being booted up in the intranet. The request is formatted as a web page. The web site is not hosted by a server that is part of the intranet. In response to receiving the request from a booting up peripheral device, the web site is configured to communicate the default device configuration to the peripheral device as a web page. Upon receiving the web page including the default device configuration, the peripheral device parses the web page to determine the settings and/or control functions specified by the default device configuration. These settings and/or control functions are used by the peripheral device to configure itself.

### TECHNICAL FIELD

The following description relates to network-connected peripheral devices in an intranet. More specifically, the following description relates to managing network-connected peripheral devices in an intranet through a firewall that protects the intranet from unauthorized access.

### BACKGROUND

Corporations typically configure their network as one or more intranets to share corporate resources and information. An Intranet is only accessible by a corporations, or organization's members, employees, or others with authorization. Intranet Web sites look and act just like any other Web sites, but a firewall surrounding an intranet fends off unauthorized access. A firewall examines each message entering or leaving the intranet and blocks those that do not meet specified predetermined security criteria.

Network administrators within an organization typically use one or more device management applications to manage peripheral devices within an organizational, or corporate intranet. A peripheral device is any device that can be connected to a computer or network such as a printer, copier, scanner, fax machine, data storage system, lab equipment, a home entertainment device, and the like. To illustrate such peripheral device management applications, consider that Hewlett Packard (HP) JetAdmin® and HP Web JetAdmin® products are used by network administrators to discover, install, monitor and troubleshoot network-connected peripherals, such as printers, in an intranet.

Before a peripheral device can be managed, devices such as networked printers must be discovered. Discovery is the process of searching the network, or intranet for devices, storing corresponding device information into a cache or database, and displaying the results in a list that is maintained by the device management application. There are a number of well-known procedures used by device management applications to discover devices on a network. However, many discovery techniques typically involve the issuance of Simple Network Transfer Protocol (SNMP) packets (broadcast or directed) in some manner. Other discovery techniques involve the issuance of other types of management protocol packets such as Service Location Protocol (SLP) packets. If these management protocol packets are filtered at an intranet firewall, discovery accuracy may suffer.

Once network-connected peripheral devices have been discovered, peripheral device management techniques also typically involve the issuance and/or exchange of management protocol packets to source or determine management information with respect to the peripheral devices. Such management information includes system status information, configuration data, software updates, and/or control commands. Thus, if management protocol packets are filtered at an intranet firewall, not only may discovery accuracy suffer, but a management application located outside the firewall may not have the ability to manage network-connected devices in the intranet.

Network administrators typically configure firewalls to filter, or block management protocol packets, such as SNMP packets from being sent into and out of organizational, or corporate intranets. Such blocking of management protocol packets prevents unauthorized access and control of peripheral devices within corporate intranets. Thus, peripheral device discovery and management techniques typically do not operate through intranet firewalls. Accordingly, peripheral device management applications are typically installed on one or more computers that have corporate intranet access.

Use of such technology to manage peripheral devices within an organization's intranet has led to a number of benefits. These benefits include: (a) comprehensive network and proactive peripheral management including configuration, troubleshooting and diagnostics to increase end-user productivity; (b) reduced Information Technology (IT) management time because of fewer required trips to printers to manually configure and troubleshoot the printers; and (c) lower total cost of network device ownership.

An organization could realize additional benefits, from a network administration perspective and from a software support perspective, if peripheral device management applications could manage an intranet's peripheral devices in a secure manner from the other side of the intranet's firewall. Such additional benefits include not having to upgrade software or install software on their sites to take advantage of peripheral device management. However, as described above, to prevent unauthorized access to corporate resources, peripheral device management solutions typically do not operate through intranet firewalls.

### SUMMARY

The system and procedure described below allows users to manage peripheral devices on a corporate intranet through a firewall that protects the intranet from unauthorized access. The system includes a web site that is used by a customer to determine a default device configuration that corresponds to one or more peripheral devices in the company intranet. The peripheral device is pre-configured to communicate a request for the default device configuration to the web site upon being booted up in the intranet. The request is formatted as a web page. The web site is not hosted by a server that is part of the intranet.

In response to receiving the request from a booting up peripheral device, the web site is configured to communicate the default device configuration to the peripheral device as a web page. Upon receiving the web page including the default device configuration, the peripheral device parses the web page to determine the settings and/or control functions specified by the default device configuration. These settings and/or control functions are used by the peripheral device to configure itself.

In this manner, peripheral devices in an intranet can be discovered and managed by the web site, which is hosted by a server that is not part of the intranet. This means that the peripheral devices in the intranet are being managed through the intranet's firewall.

### BRIEF DESCRIPTION OF THE DRAWINGS

The same numbers are used throughout the drawings to reference like features and components.

FIG. 1 is a block diagram of an exemplary system to manage peripheral devices in an intranet through a firewall.

FIG. 2 is a flowchart diagram of an exemplary procedure to manage peripheral devices in an intranet through a firewall.

### DETAILED DESCRIPTION

Exemplary System

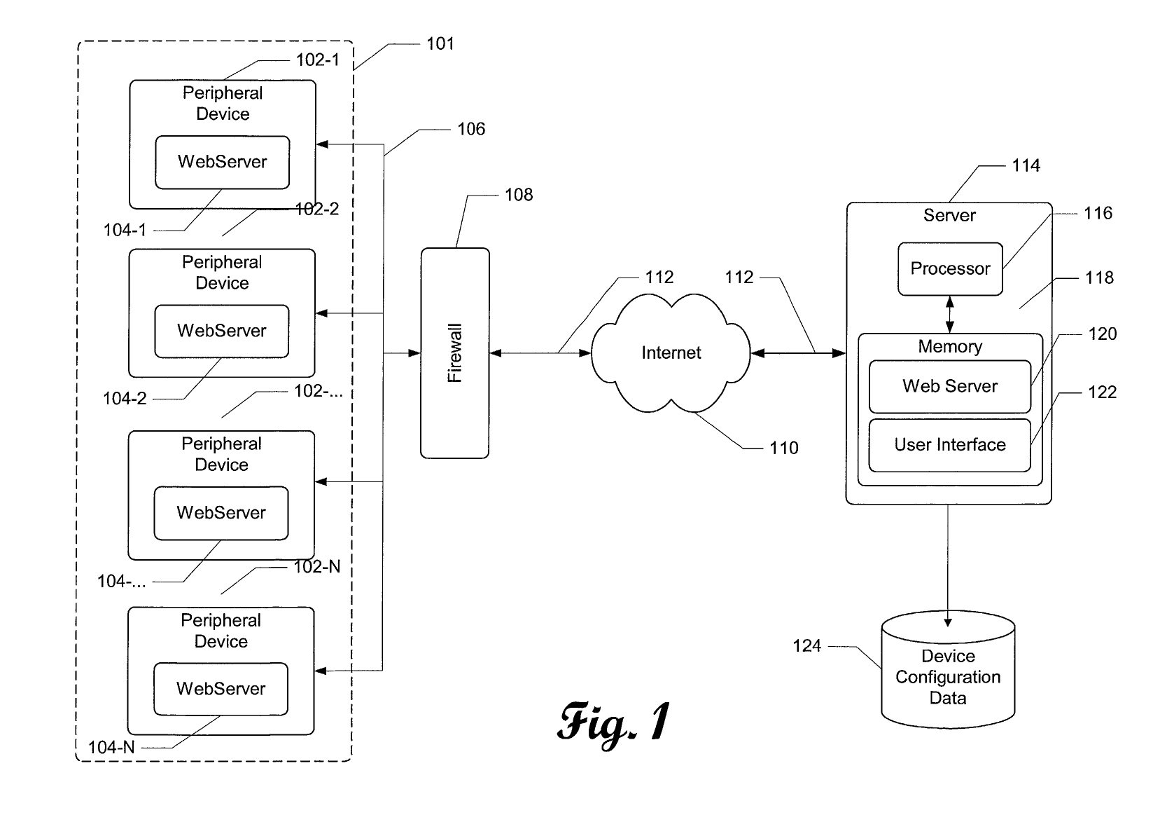

FIG. 1 is a block diagram of a system 100 to manage peripheral devices in an intranet through a firewall. The system includes an intranet 101 comprising one or more peripheral devices 102 that are logically connected across communication pathways 106 to a firewall 108. The logical connections 106 in the system can be through a local area network (LAN) and a wide area network (WAN).

Firewall 108 examines each message entering or leaving the intranet and blocks those that do not meet predetermined specified security criteria. In this implementation, the firewall blocks SNMP messages from entering or leaving the intranet 101. Firewall 108 is coupled across communication pathways 112 to Internet 108, which is coupled to a peripheral device management server 114.

Each peripheral device 102 includes a processor (not shown) configured to execute a respective web server application 104. The web server application is configured to send a web page to a predetermined web site hosted the peripheral device management server 104. The web site is predetermined because each peripheral device is pre-configured before it is installed into the intranet 101 to send a request to the web site upon booting up into the intranet.

In response to a peripheral device 102 communicating the request to the web site hosted by the server 114, the requesting peripheral device receives a web page with a predetermined device configuration from the server 114. Aspects of an exemplary procedure to determine the predetermined device configuration are described in greater detail below in reference to server 114.

In response to receiving the predetermined device configuration, the peripheral device parses the web page to determine one or more device settings or resources specified by the predetermined device configuration to configure itself. The received predetermined device configuration includes, for example, control commands encoded as XML and wrapped in HTTP. Such control commands include, for example SNMP control commands.

In one implementation, the predetermined web site provides a printer management service, the predetermined device configuration is a printer configuration, and the peripheral device is a printer.

A peripheral device 102 is also configured to send an e-mail message, or notification message to the server when an event occurs, such as a predetermined error condition. In one implementation, the notification message includes information to clearly identify the particular peripheral device that communicated the e-mail message.

In response to sending the notification message, the peripheral device is configured to receive a notification response based on the notification message from the predetermined web site. In one implementation, a response includes a set of control functions to be implemented upon receipt by the peripheral device. The response could also be selected from a group of responses including the ordering a toner cartridge for the printer or dispatching a service representative to service the peripheral device.

Server 114 includes a processor 116 connected to memory 118. The memory includes both volatile memory and non-volatile memory in the form of random access memory (RAM) and read-only memory (ROM). The processor fetches and executes computer program instructions from the memory. Such computer program instructions include the following computer programs: web server 120 and optional user interface 122.

Server 114 provides peripheral device management through the firewall 108. To accomplish this, the web server 120 receives a request from a peripheral device 102. In response to receiving the request, web server 120 generates a response based on the request. The response is a web page. The response includes one or more control commands used by the requesting peripheral device to perform one or more management functions. The response is communicated by the web server 120 to the embedded web server 104 on the requesting peripheral device.

In one implementation, the request is for a default device configuration 126 for the requesting peripheral device. The configuration 126 may correspond to the respective configurations of each peripheral device 102 in the intranet 101, or the configuration may correspond to the configuration(s) of only a subset of the peripheral devices. For example, one default configuration may apply to each printer in a company, or there may be a number of default configurations, each being based on a particular printer model.

The default device configuration is determined prior to booting up the peripheral device in the intranet 101. To determine the default device configuration web server 120 serves a device configuration web page (not shown) to a network management device (not shown) with access to the intranet 101. Device configuration user interfaces are well-known. Upon viewing the web page, a network administrator inputs configuration settings for the peripheral devices. In another implementation, server 114 includes a user interface 122, which is displayed on a display device (not shown) and used to facilitate input of the default device configuration.

Significantly, the peripheral device management server 104 is not in the intranet. Thus, system 100 provides for management of peripheral devices 102 in a company intranet 101 through a firewall 108 by a management device 114 that is not part of the intranet. The identity of the management device can be determined before each peripheral device is pre-configured to ensure that a trusted party will be managing the peripheral devices.

The functionality of the peripheral devices 102 and server 114 described herein includes various types of computer-readable media when such media contain instructions, programs, and/or modules for implementing the steps described herein in conjunction with a microprocessor or other data processors. Generally, such modules include routines, programs, objects, components, data structures, etc. that perform particular tasks or implement particular abstract data types.

Tasks might also be performed by remote processing devices that are linked through a communications network. In a distributed computing environment, program modules may be located in both local and remote computer storage media. The invention also includes a computer itself when programmed according to the methods and techniques described herein.

Exemplary Procedure

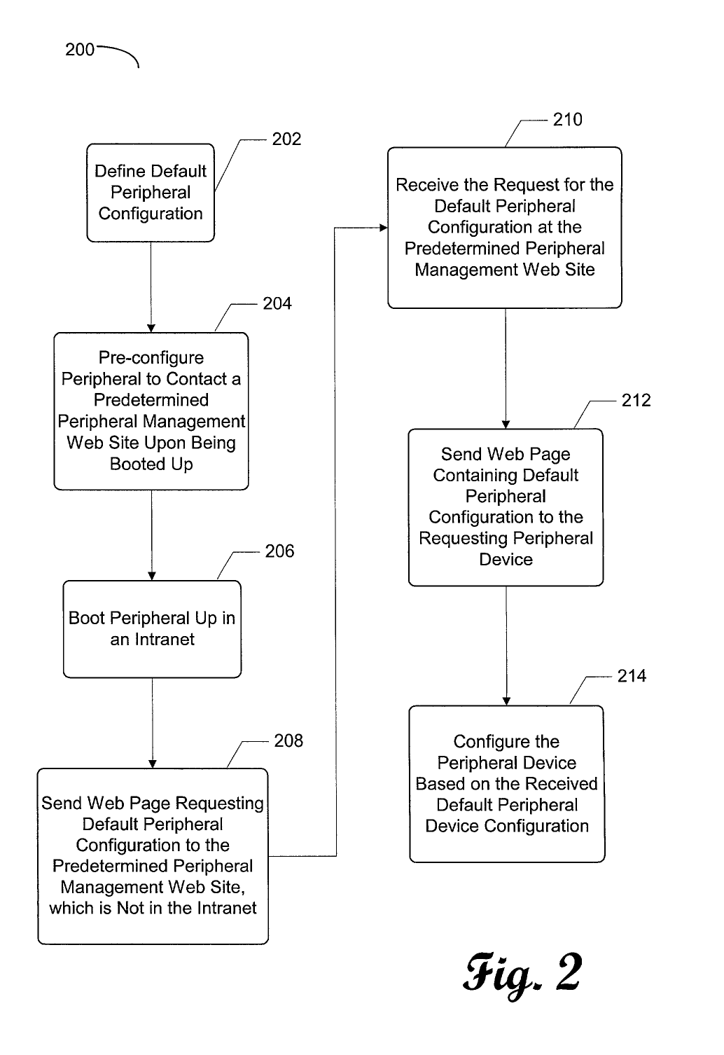

FIG. 2 is a flowchart showing an exemplary procedure 200 to provide peripheral device management through a firewall. At step 202, the procedure defines a default peripheral configuration. At step 204, the procedure preconfigures a peripheral to contact a predetermined peripheral management website upon being booted up. At step 206, the procedure boots the peripheral up into an intranet. At step 208, the procedure sends a web page requesting the default peripheral configuration. The request is sent to the predetermined peripheral management website, which is not in the Internet. At step 210, the procedure receives the request for the default peripheral configuration at the predetermined peripheral management web site. At step 212, the procedure sends a web page containing the default peripheral configuration to the requesting peripheral device. At step 214, in response to receiving the web page containing the default peripheral configuration, the peripheral configures itself based on the received default peripheral configuration.

Conclusion

Although details of specific implementations and embodiments are described above, such details are intended to satisfy statutory disclosure obligations rather than to limit the scope of the following claims. Thus, the invention as defined by the claims is not limited to the specific features described above. Rather, the invention is claimed in any of its forms or modifications that fall within the proper scope of the appended claims, appropriately interpreted in accordance with the doctrine of equivalents.

I claim:

1. A method providing peripheral device management through a firewall, the firewall blocking unauthorized access to a plurality of peripheral devices in an intranet, the method comprising:
pre-configuring a peripheral device to communicate a request to a predetermined web site upon booting up in the intranet, the web site being hosted by a server that does not have direct intranet access;
receiving the request at the predetermined web site from the preconfigured peripheral device;
in response to receiving the request:
generating a response based on the request, the response comprising one or more control commands used by the preconfigured peripheral device to perform one or more functions; and
communicating the response to the preconfigured peripheral device.

2. A method as recited in claim 1, wherein the predetermined web site is a printer management service, the response is a printer configuration, and the peripheral device is a printer.

3. A method as recited in claim 1, wherein the request is a configuration request, the method further comprising:
determining a default device configuration corresponding to the peripheral device; and
wherein the response further comprises the default device configuration.

4. A method as recited in claim 3, wherein the determining further comprises presenting a user interface to a customer for the customer to select one or more configuration settings corresponding to the peripheral device.

5. A method as recited in claim 3, wherein the determining further comprises identifying an action for the peripheral devices to take upon occurrence of a condition.

6. A method as recited in claim 3, wherein the forwarding further comprises:
encoding the device configuration as a web page comprising XML; and
wrapping the encoded device configuration in HTTP such that a peripheral device that includes an embedded web server can parse and execute the encoded device configuration to configure one or more settings or resources that correspond to the peripheral device.

7. A method as recited in claim 1, further comprising:
providing an e-mail address, the request being a notification message that is communicated to the e-mail address;

8. A method as recited in claim 7, wherein the peripheral device is a printer and the response is selected from a group of responses comprising of ordering a toner cartridge for the printer or dispatching a service representative to service the printer on-site.

9. A method as recited in claim 1, the method comprising:
providing an e-mail address, the request being a notification message being sent in response to the occurrence of a condition on the peripheral device;
the managing further comprising:
determining a response based on the notification message, the response specifying a set of control functions that address the notification message; and
forwarding the response to the peripheral device such that the peripheral device can implement the set of control functions.

10. A computer-readable medium storing computer-executable instructions that, when executed on a computer, performs the method of claim 1.

11. A method comprising:
communicating, by a peripheral device in a corporate intranet, a configuration request to a predetermined web site hosted by a server that is not in the corporate intranet;
in response to the communicating, receiving a predetermined device configuration from the predetermined web site; and
in response to the receiving, configuring the peripheral device based on the predetermined device configuration.

12. A method as recited in claim 11, wherein the predetermined web site provides a printer management service, the predetermined device configuration is a printer configuration, and the peripheral device is a printer.

13. A method as recited in claim 11, wherein the peripheral device comprises an embedded web server for generating Web pages, the communicating further comprising encoding the configuration request as a Web page.

14. A method as recited in claim 11, wherein:
the peripheral device comprises an embedded web server for parsing Web pages,
the received predetermined device configuration is a web page comprising encoded XML wrapped in HTTP,
the configuring further comprising:
parsing the XML and HTTP to determine one or more device settings or resources specified by the predetermined device configuration.

15. A method as recited in claim 11, further comprising:
in response to a condition, forwarding, a notification message to the predetermined web site;
receiving a notification response based on the notification message from the predetermined web site, the response comprising a set of control functions; and
in response to receiving the notification response, implementing one or more of the set of control functions.

16. A computer-readable medium storing computer-executable instructions that, when executed on a computer, performs the method of claim 11.

17. A system comprising:
a web site being configured to determine a default device configuration corresponding to a peripheral device, the peripheral device being preconfigured to communicate a request to the web site upon being booted up in an intranet that is protected by a firewall, the web site not being hosted by a server that is part of the intranet,
in response to receiving the request, the web site is configured to communicate the default device configuration to the peripheral device, the default device configuration being communicated through the firewall, the default device configuration being used by the peripheral device to configure itself.

18. A system as recited in claim 17, wherein the peripheral device comprises an embedded web server to communicate the request as a web page and to parse the communicated default device configuration, the communicated default device configuration being communicated as a web page.

19. A system as recited in claim 19, wherein the server that hosts the web site comprises an e-mail address, the request being communicated to the e-mail address, the request comprising a notification message that was generated by the peripheral device in response to a predetermined condition, the response being based on the received request.

20. A system as recited in claim 19, wherein the response comprises one or more control codes corresponding to functions to be performed by the peripheral device upon receipt of the response.
